(19) United States
(12) Patent Application Publication
(10) Pub. No.: US 2006/0190562 A1
(43) Pub. Date: Aug. 24, 2006

(54) Information provision brokerage system, information provision brokerage method and computer program

(76) Inventor: Takashi OHNO, Kanagawa (JP)

Correspondence Address: Staas & Halsey, Suite 700, 1201 New York Avenue, Washington, DC, 20005, US

(21) Appl. No.: 10/552,150

(22) PCT Filed: Apr. 9, 2003
(86) PCT No.: PCT/JP03/04533

§ 371 Date: Oct. 7, 2005

(51) Int. Cl. G06F 15/16

(52) U.S. Cl. 709/218; 709/224

(57) ABSTRACT

A brokerage system (1) is provided with a data management portion (104), a transmission permission determining portion (106) and an information transmission portion (107). The data management portion (104) stores provider area information indicating an area designated by an information provider and provision information 70 that is provided by the information provider. In addition, it stores user area information indicating an area designated by a user. The transmission permission determining portion (106) determines whether or not an area designated by an information provider overlaps an area designated by a user. The information transmission portion (107) transmits provision information (70) of an information provider to a terminal device of a user if it is determined that an area designated by the information provider overlaps an area designated by the user.

### TECHNICAL FIELD

The present invention relates to a system and method for performing brokerage for transmitting information of an information provider to a user.

### BACKGROUND ART

Conventionally, there is proposed a system for acting for a service provider such as a company, a shop or a public facility that provides a service to customers (users) so as to deliver information about the service to users.

For example, Japanese unexamined patent publication No. 2002-123741 and No. 2002-216021 disclose systems in which information is delivered to terminal devices of users who are within the area designated by a service provider. Therefore, if a service provider designates an area in the proximity of the service provider, information can be delivered to users who have high possibility of visiting a shop of the service provider or the like.

However, it is not always efficient to transmit information uniformly to all users within a designated area as the above-mentioned system. It is because that it depends on a moving speed or activity of a user how far or close the user feels a shop of the service provider is, and it is not uniform for all users.

Therefore, a user who can move fast or a user who has a wide range of action may have a high possibility of visiting the shop or the like even if the user is not close to the designated area, for example. In this case, it is worthwhile delivering information to the user. On the contrary, if a user is within the designated area but cannot move fast or does not have a wide range of action, there may be little effect of delivering information to the user unless he or she is close to the service provider.

An object of the present invention is to facilitate delivering information more efficiently than the conventional method.

### DISCLOSURE OF THE INVENTION

An information provision brokerage system according to the present invention includes a provider information storage portion for storing provider area information and provision information for each information provider, the provider area information indicating an area designated by the information provider, and the provision information being to be provided by the information provider; a user information storage portion for storing user area information for each user who has a terminal device, the user area information indicating an area designated by the user; a determining portion for determining whether or not an area indicated by the provider area information overlaps an area indicated by the user area information; and an information transmission portion for transmitting the provision information of the information provider according to the provider area information to a terminal device of the user according to the user area information if it is determined that the area indicated by the provider area information overlaps the area indicated by the user area information.

Preferably, an area in which the provision information can be provided is divided into plural segment areas, the provider information storage portion stores the provider area information that indicates the segment area, the user information storage portion stores the user area information that indicates the segment area, and the determining portion performs the determination by determining whether or not the same segment area is included both in the segment area indicated by the provider area information and in the segment area indicated by the user area information.

Moreover, the system includes a movement information obtaining portion for obtaining movement information that indicates a speed and a direction of movement of the user, and an area information changing portion for changing the user area information of the user in accordance with the movement information of the user, wherein the determining portion performs the determination in accordance with the user area information changed by the area information changing portion.

Moreover, the provision information storage portion stores category information that indicates a category of contents of the provision information in association with the provision information, the user information storage portion stores category information that indicates a category of information desired by the user in association with the user, and the information transmission portion transmits the provision information if a category of contents of the provision information to be transmitted is included in a category of information desired by the user who is a destination of the transmission.

Moreover, the provision information storage portion stores provider location information that indicates a location of the information provider in association with the information provider, the user information storage portion stores user location information that indicates a location of the user and a distance designated by the user in association with the user, and the information transmission portion transmits the provision information if a distance between a location of the information provider who provides the provision information to be transmitted and a location of the user who is a destination of the transmission is smaller than the distance of the user.

Moreover, the system includes a notification portion for sending a notification to a terminal device of the user according to the user area information so that the user receives the provision information of the information provider according to the provider area information if it is determined that an area indicated by the provider area information overlaps an area indicated by the user area information, and the information transmission portion transmits the provision information of the information provider to the terminal device of the user responding to a request from the user who received the notification.

A server that can connect to the information provision brokerage system via a network is provided for each of information providers. This server includes a user registration portion for receiving an application from the user for information delivery so as to register the user as an information delivery destination user, an information delivery portion for performing delivery of information to the user who is registered as the information delivery destination user, a delivery status management portion for managing a delivery status of information, a delivery status notification portion for notifying the information providing server of the delivery status, and a delivering terminal device. As the server, not only a so-called server machine but also a terminal device such as a personal computer can be used.

### BRIEF DESCRIPTION OF THE DRAWINGS

FIG. 1 is a diagram showing an example of an overall structure of an information transmission and reception system.

FIG. 2 is a diagram showing an example of an information setting screen.

FIG. 3 is a diagram showing an example of a hardware structure of a brokerage system.

FIG. 4 is a diagram showing an example of a functional structure of a brokerage system.

FIG. 5 is a diagram showing an example of a structure of a data management portion.

FIG. 6 is a diagram showing an example of plural areas obtained by dividing a provision region of a brokerage service.

FIG. 7 is a diagram showing an example of an area definition table.

FIG. 8 is a diagram showing an example of a service provider table.

FIG. 9 is a diagram showing a relationship between an obtained area and a delivery area.

FIG. 10 is a diagram showing an example of a delivery area setting screen.

FIG. 11 is a diagram showing an example of a user presence information table.

FIGS. 12(a) and 12(b) are diagrams showing an example of obtaining condition tables.

FIGS. 13(a)-13(c) are diagrams showing an example of a method for determining the obtained area.

FIGS. 14(a) and 14(b) are diagrams showing an example of area condition setting screens.

FIGS. 15(a) and 15(b) are diagrams showing an example of a list display screen.

FIG. 16 is a diagram showing an example of an advertising information screen.

FIG. 17 is a diagram showing an example of an area extension table.

FIG. 18 is a diagram showing an example of a category selecting screen.

FIG. 19 is a diagram showing an example of a structure of a transmission permission determining portion.

FIG. 20 is a diagram showing an example of a structure of a membership registration management portion.

FIG. 21 is a diagram showing an example of a membership information screen.

FIG. 22 is a diagram showing an example of a delivery count table.

FIG. 23 is a diagram showing an example of an admission management table.

FIG. 24 is a flowchart showing an example of a flow of a general process of an information transmission and reception system.

FIG. 25 is a flowchart showing an example of a flow of a process for delivering information to a user in a case of timing (1).

FIG. 26 is a flowchart showing an example of a flow of a process for delivering information to a user in a case of timing (2).

FIG. 27 is a flowchart showing an example of a flow of a process for delivering information to a user in a case of timing (3).

FIG. 28 is a diagram showing an example of a statistics screen.

### BEST MODE FOR CARRYING OUT THE INVENTION

The present invention will be described in more detail in accordance with the attached drawings.

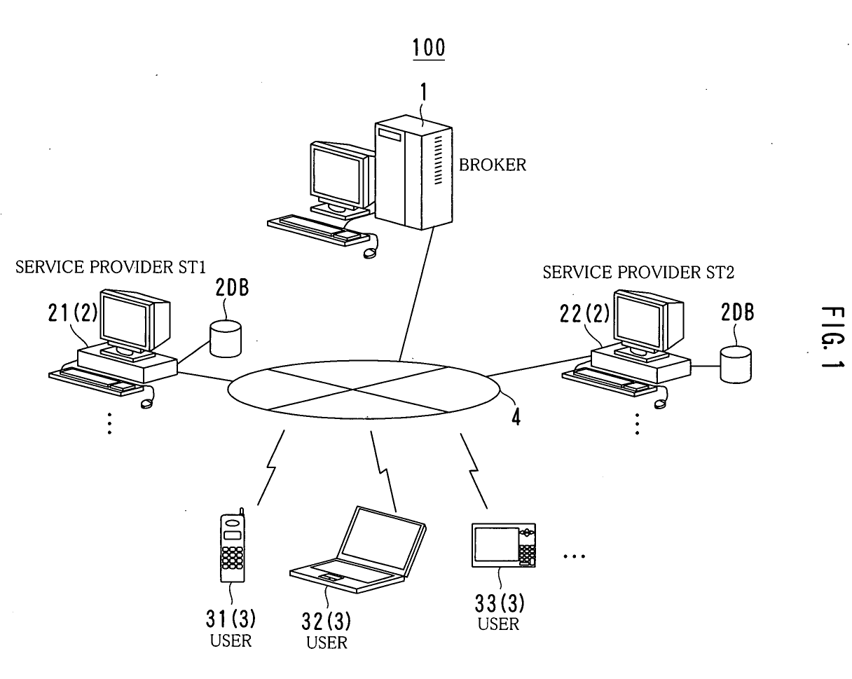

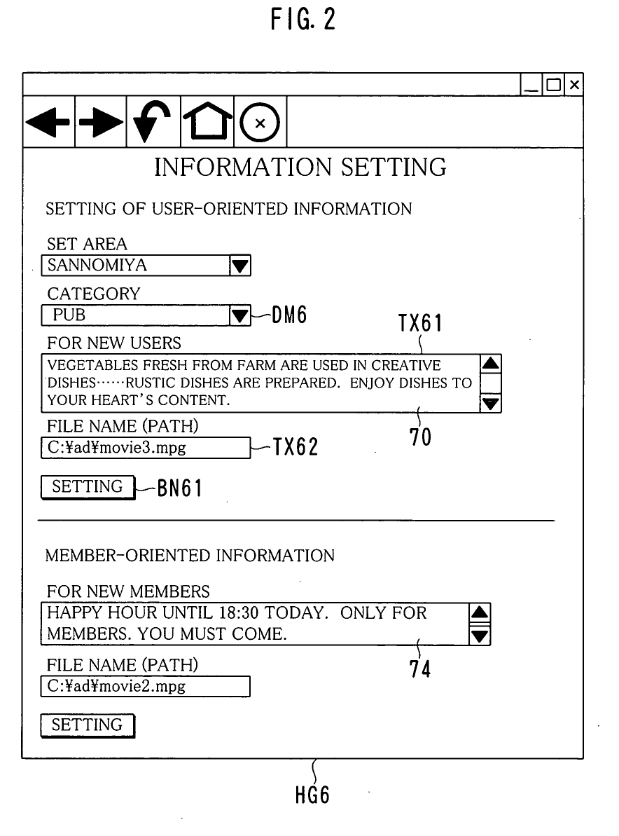

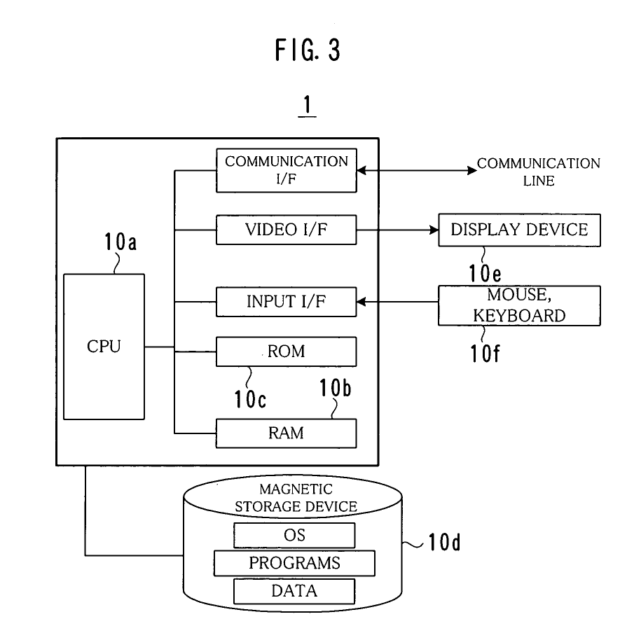

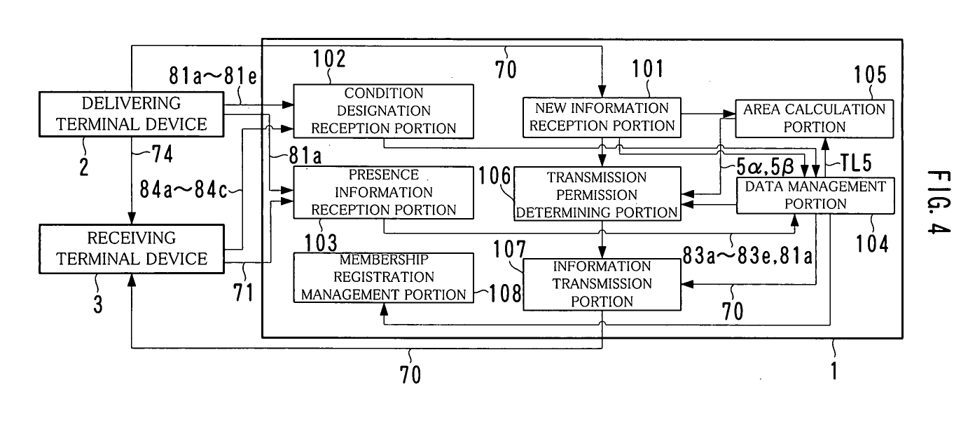

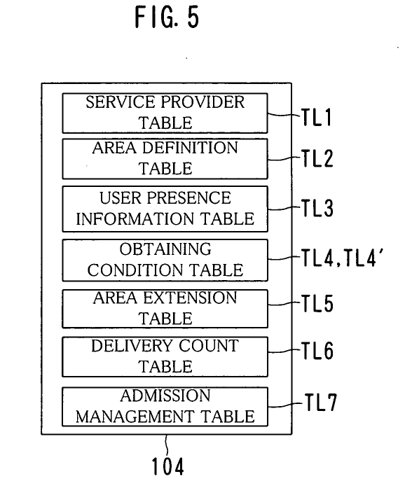

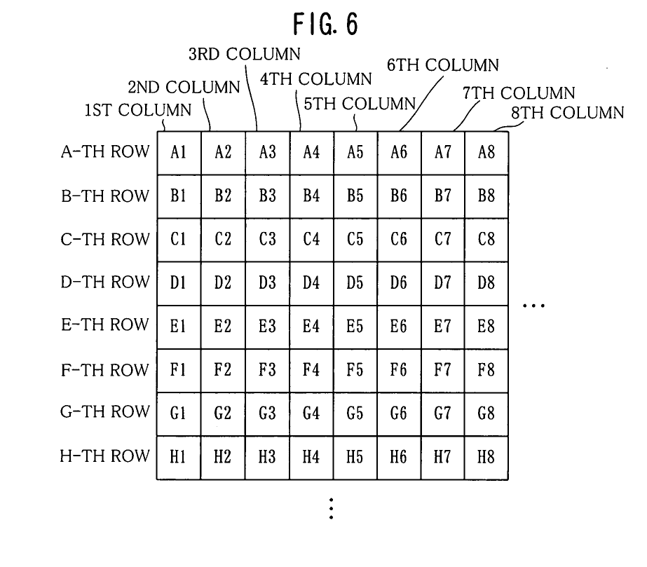

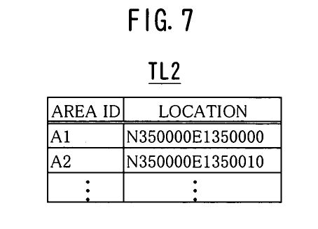

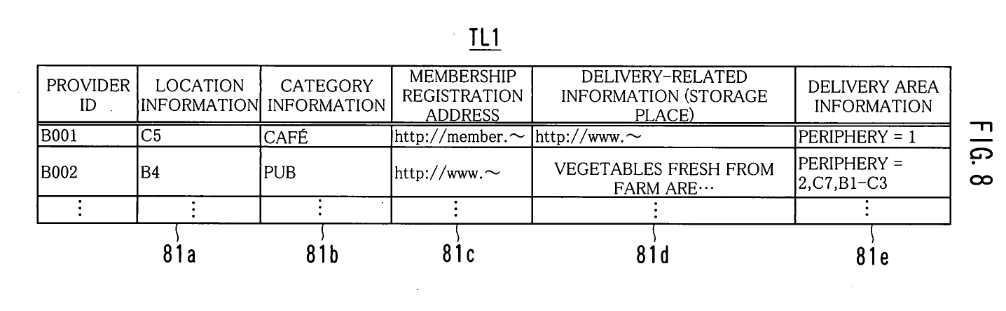

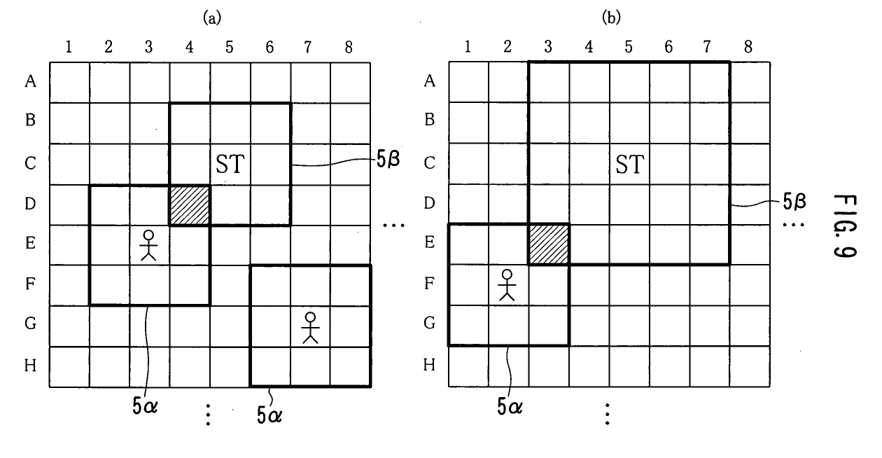

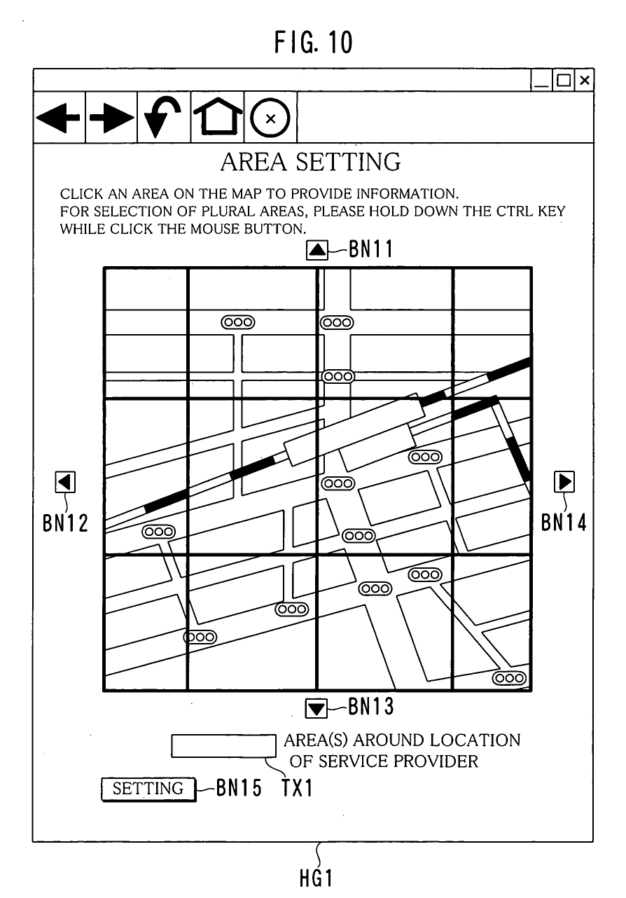

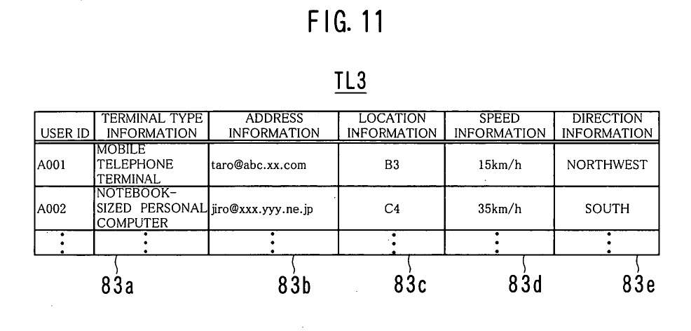

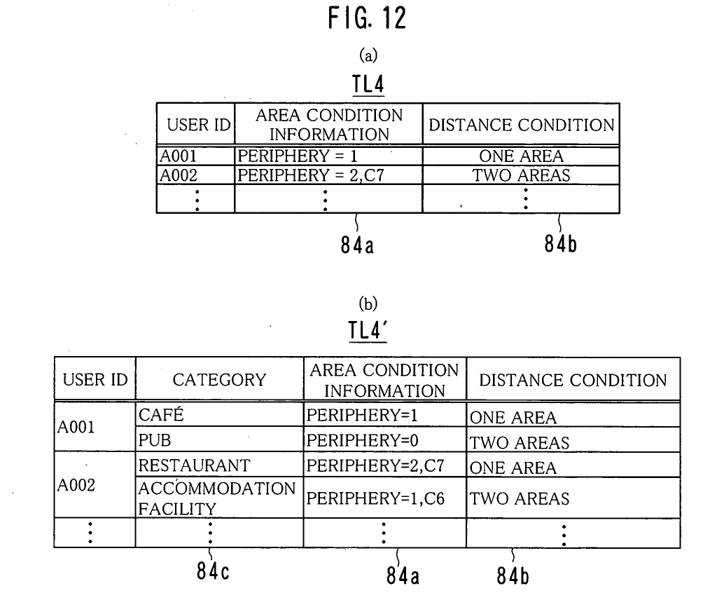

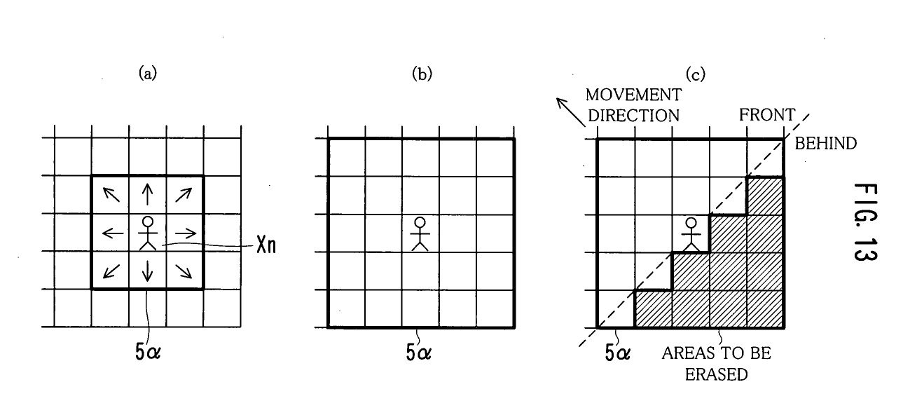

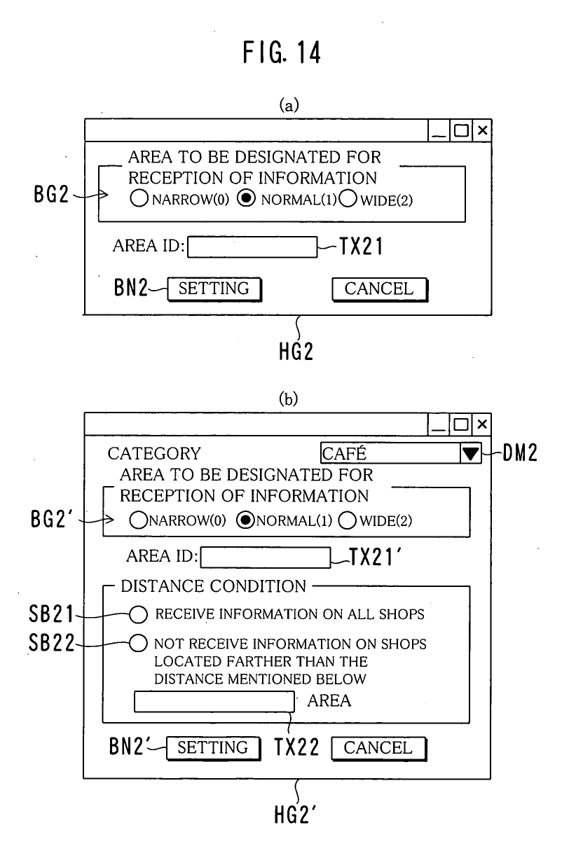

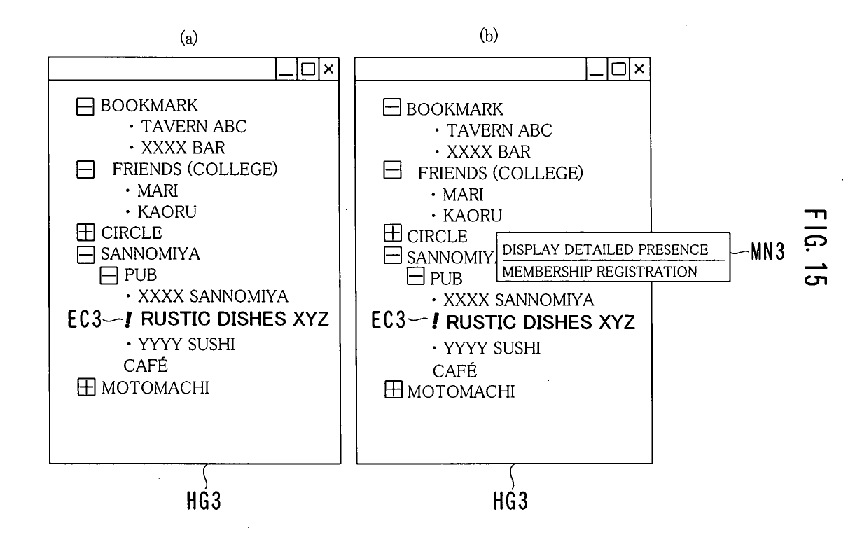

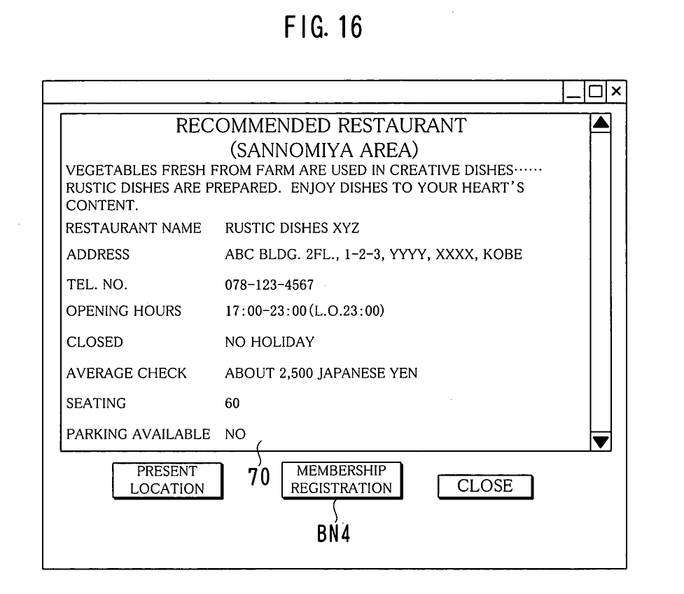

FIG. 1 is a diagram showing an example of an overall structure of an information transmission and reception system 100, FIG. 2 is a diagram showing an example of an information setting screen HG6, FIG. 3 is a diagram showing an example of a hardware structure of a brokerage system 1, FIG. 4 is a diagram showing an example of a functional structure of a brokerage system 1, FIG. 5 is a diagram showing an example of a structure of a data management portion 104, FIG. 6 is a diagram showing an example of plural areas obtained by dividing a provision region of a brokerage service, FIG. 7 is a diagram showing an example of an area definition table TL2, FIG. 8 is a diagram showing an example of a service provider table TL1, FIG. 9 is a diagram showing a relationship between an obtained area 5a and a delivery area 5B, FIG. 10 is a diagram showing an example of a delivery area setting screen HG1, FIG. 11 is a diagram showing an example of a user presence information table TL3, FIGS. 12(a) and 12(b) are diagrams showing an example of obtaining condition tables TL4 and TL4′, FIGS. 13(a)-13(c) are diagrams showing an example of a method for determining the obtained area 5a, FIGS. 14(a) and 14(b) are diagrams showing an example of area condition setting screens HG2 and HG2′, FIGS. 15(a) and 15(b) are diagrams showing an example of a list display screen HG3, and FIG. 16 is a diagram showing an example of an advertising information screen HG4.

As shown in FIG. 1, the information transmission and reception system 100 includes a brokerage system 1 according to the present invention, delivering terminal devices 2 (21, 22, . . . ), receiving terminal devices 3 (31, 32, . . . ), and a communication line 4. As the communication line 4, the Internet, an intranet, a public telephone line or a private line can be used. The brokerage system 1, the delivering terminal device 2 and the receiving terminal device 3 can be connected to each other via the communication line 4.

The delivering terminal device 2 is provided for each of service providers ST (S1, S2, . . . ) such as a company, a shop, a visitor center or a public facility that provides various services to customers (users). These service providers ST can ask the brokerage system 1 to deliver (provide) information to users, and the information is for guidance, advertisement or introduction about services of the service providers ST or surrounding areas. Hereinafter, such information is referred to as “user-oriented information 70”. In addition, the service provider ST provides information such as special guidance only to the users who entered a society administrated by the service provider ST, i.e., only the members of the society. Hereinafter, such information is referred to as “member-oriented information 74”.

As the delivering terminal device 2, a personal computer or a workstation can be used. An application program for editing texts, images, videos, sounds or the like so as to generate the user-oriented information 70 or the like is installed in the delivering terminal device 2. In addition, an application program for uploading data including the generated user-oriented information 70 and an application program for electronic mail or instant messaging (IM) are also installed in the same. As an application program for IM, Instant Messenger of AOL Company can be used, for example.

A staff of the service provider ST operates the delivering terminal device 2 so as to upload the generated user-oriented information 70 to the brokerage system 1. For example, the user-oriented information 70 is generated by filling in a text box TX61 of the information setting screen HG6 shown in FIG. 2 with guidance of a service. Alternatively, a file of data such as an image to be contents of the user-oriented information 70 is designated in the text box TX62. Then, a setting button BN61 is clicked so that the entered contents or the designated file is uploaded.

Note that the member-oriented information 74 can also be generated by the information setting screen HG6 in the same manner as the case of the user-oriented information 70.

A user who wants to obtain the user-oriented information 70 delivered (provided) by the service provider ST is required to have at least one receiving terminal device 3. The receiving terminal device 3 is provided with a function for performing communication with the brokerage system 1 or the delivering terminal device 2 and a function for obtaining location information of the receiving terminal device 3. In order to realize the former function, an electronic mail program or an IM application program and the like are installed in it. In order to realize the latter function, it is provided with hardware and an application program or the like for GPS (Global Positioning Systems), for example.

If the user wants to obtain the user-oriented information 70 in the neighborhood away from home, it is desirable that the user carries a portable terminal device such as a notebook-sized personal computer, a mobile telephone terminal, a PHS terminal or a PDA (Personal Digital Assistant) as the receiving terminal device 3. Alternatively, a terminal device of a navigation system may be used when the user goes out by automobile.

The brokerage system 1 performs a process for relaying the user-oriented information 70 delivered from the delivering terminal device 2 to the receiving terminal device 3. Namely, it performs brokerage for exchange of information between the service provider ST and the user (customer). The brokerage system 1 is administrated by an ISP (Internet Service Provider), a communication company, an advertising agency or the like, for example.

The brokerage system 1 includes a CPU 10a, a RAM 10b, a ROM 10c, a magnetic storage device 10d, a display device 10e, an input device 10f such as a mouse or a keyboard and various types of interfaces as shown in FIG. 3. An operating system (OS) and programs and data for realizing functions that will be described later are installed in the magnetic storage device 10d. These programs and data are loaded to the RAM 10b if necessary, and the program is executed by the CPU 10a. The brokerage system 1 may be constituted of one server machine as shown in FIG. 1 or plural server machines and peripheral devices.

According to this structure, functions including a new information reception portion 101, a condition designation reception portion 102, a presence information reception portion 103, an area calculation portion 105, a transmission permission determining portion 106, an information transmission portion 107, a membership registration management portion 108 and a data management portion 104 are realized in the brokerage system 1 as shown in FIG. 4. Note that the membership registration management portion 108 may be realized by using a server that is independent of the brokerage system 1.

Hereinafter, the portions of the brokerage system 1 shown in FIG. 4, and functions of the delivering terminal device 2 and the receiving terminal device 3 will be described.

The data management portion 104 stores a service provider table TL1, an area definition table TL2, a user presence information table TL3, obtaining condition tables TL4 and TL4′, an area extension table TL5, a delivery count table TL6, an admission management table TL7 and the like as shown in FIG. 5.

In this embodiment, a provision region of the brokerage service performed by the brokerage system 1, namely an area where the user-oriented information 70 can be delivered is divided into plural areas as shown in FIG. 6. The “area” is a rectangular area obtained by dividing the provision region of the brokerage service by ten seconds each in the latitude direction and in the longitude direction. Namely, if the provision region of the brokerage service is at about 35 degrees north latitude, a length of one area in a north-south direction and in an east-west direction is approximately 200-300 meters. Each area is assigned an area ID such as A1, A2 or B1.

A location of each area is defined by the area definition table TL2 as shown in FIG. 7. In the area definition table TL2, the “location” indicates coordinates of the southwest apex of the area (box). Therefore, For example, an area A1 is in the range between 35°00′00″-35°00′10″ north latitudes and 135°00′00″-135°00′10″ east longitude.

Note that although a simple area ID such as “A1” is used as the area ID for simplifying description in this embodiment, it is possible to use coordinates of an apex (the southwest apex, for example) in the area like “N350000E1350000”. In addition, although the provision region of the brokerage service is divided by 10 seconds each in the latitude direction and in the longitude direction so as to make the area, it is possible to divide into smaller or larger areas. It is possible to change a size of the area in accordance with an environment or the like of each region. For example, a downtown may be divided into smaller areas, while an underpopulated region may be divided into larger areas. Alternatively, it is possible to divide into areas corresponding to towns or wards such as “?? Chou” or “?? 1-Choume”. In this case, zip codes assigned to towns or wards may be used as area IDs.

The service provider table TL1 stores location information 81a, category information 81b, a membership registration address 81c, delivery-related information 81d, delivery area information 81e and the like in association with a provider ID for identifying the service provider ST, as shown in FIG. 8.

The location information 81a indicates a present location of the service provider ST. Although the present location is indicated by the area ID of the area where the service provider ST exists in FIG. 8, it is possible to indicate it by coordinates (of a latitude and a longitude). In this case, the area where the service provider ST exists can be known by referring to the area definition table TL2 shown in FIG. 7.

The delivery-related information 81d indicates items about the user-oriented information 70 that is uploaded by the service provider ST. This delivery-related information 81d is stored (registered) in the service provider table TL1 by the new information reception portion 101 shown in FIG. 4 as follows.

The new information reception portion 101 discriminates a data format of the user-oriented information 70 received from the receiving terminal device 3 of the service provider ST. If the user-oriented information 70 is binary data such as image data, moving image data or sound data, the user-oriented information 70 is stored in the predetermined directory of the magnetic storage device 10d. Then, the storage position thereof is stored as the delivery-related information 81d in the service provider table TL1.

If the user-oriented information 70 is text data, the user-oriented information 70 is stored without any change as the delivery-related information 81d. It is, for example, the case where the user-oriented information 70 includes only a short text or indicates only a URL of a Web site of the service provider ST. However, text data having a large size may be handled in the same manner as the case of binary data.

The delivery area information 81e shown in FIG. 8 is for designating an area to which the service provider ST wants to deliver the user-oriented information 70 (hereinafter referred to as a “delivery area 5B”). There are two methods for designating an area as follows.

One is a method in which a relative area viewed from a location of the service provider ST is designated. For example, “periphery=1” is designated in the delivery area information 81e of the service provider ST corresponding to “provider ID=B001”. This means that the location (area C5) of this service provider ST and the range of extension from the location in the surrounding eight directions by one area each (areas B4-B6, C4, C6, D4-D6) become the delivery area 53 as shown in FIG. 9(a).

Therefore, if the service provider ST provides the service while moving like a mobile shop, a mobile library or a mobile blood bank, the delivery area 5B will change along with the location of the service provider ST.

Another is a method in which an area in the provision region (namely on a map) shown in FIG. 6 is designated directly. For example, the delivery area information 81e of the service provider ST corresponding to “provider ID=B002” includes designation of “C7”. This indicates an area C7 that is a fixed (absolute) area in the provision region. This designation method is convenient in the case of designating an area in a terminal station where many people gather or along a main road. Note that the designation of “B1-C3” means designating a rectangle having a diagonal line that connects the areas B1 and C3 as the delivery area 5B.

The delivery area information 81e is stored in the service provider table TL1 in the following procedure, for example. The service provider ST gains access to a predetermined Web page of the brokerage system 1 so as to display a delivery area setting screen HG1 shown in FIG. 10 on the delivering terminal device 2 of the service provider ST. Each of the rectangular areas shown by thick lines on the map corresponds to each of the areas shown in FIG. 6 and are assigned an area ID (see FIG. 7).

The service provider ST searches a desired delivery area while scrolling the map by clicking scroll buttons BN11-BN14. Then, one or more areas that should be designated as delivery areas are clicked, and after that the setting button BN15 is clicked. If the service provider ST wants to designate an area that is relative to his or her location, a numerical value is designated in the text box TX1.

Then, information indicating the designated area is transmitted to the brokerage system 1. The condition designation reception portion 102 shown in FIG. 4 receives the information and makes the service provider table TL1 store the information as the delivery area information 81e.

Note that the category information 81b and the membership registration address 81c shown in FIG. 8 will be described later.

The user presence information table TL3 stores terminal type information 83a, address information 83b, location information 83c, speed information 83d, direction information 83e and the like of each user for discriminating the user in association with a user ID as shown in FIG. 11.

The terminal type information 83a indicates a type of the receiving terminal device 3 owned by the user. The address information 83b indicates an address given to the receiving terminal device 3. As this address, an address that is used when the receiving terminal device 3 performs an instant messaging is used, for example. The location information 83c indicates a present location of the user. The speed information 83d indicates a speed of movement of the user. The direction information 83e indicates a direction of movement of the user.

The information is stored in the user presence information table TL3 as follows. The receiving terminal device 3 receives radio wave transmitted from a GPS satellite or a base station for cellular phones at a certain time interval so as to obtain its location. An area where the user exists can be known from the relationship shown in FIG. 7. When a new location is obtained, it is determined whether or not the present area of the user is different from the area where the user was. Then, if the areas are different from each other, information indicating the present area is transmitted to the brokerage system 1 as the presence information 71.

In addition, every time when a new location is obtained, movement information that indicates a speed and a direction of movement of the user is determined in accordance with the new location and the previous location. Then, if there is a change in the speed or the direction, the obtained movement information is transmitted to the brokerage system 1 as the presence information 71.

In the same way, if there is a change in a type or an address of the terminal device, the presence information 71 that indicates contents of the change is transmitted to the brokerage system 1. Note that the transmission of the presence information 71 indicating a present location, a type of the terminal device, an address and others is performed also when the brokerage service by the brokerage system 1 starts to be used.

Then, the presence information reception portion 103 shown in FIG. 4 stores each of information included in the presence information 71 that is received from the receiving terminal device 3 in the user presence information table TL3 so as to interrelate with the user ID of the user.

The obtaining condition table TL4 stores area condition information 84a and distance condition information 84b for each user in association with the user ID of the user as shown in FIG. 12(a).

The area condition information 84a indicates a condition for determining whether the user-oriented information 70 should be delivered or not, and it designates an area where the user is predicted to visit in a short time (in a few tens of minutes) or an area in which the user is interested. When an area is designated in accordance with the area condition information 84a, the user-oriented information 70 of the service provider ST who exists in the area or in the vicinity of the area is delivered to a user who made the designation. Therefore, the wider the area designated by the area condition information 84a, the wider area the service provider ST can exist and deliver the user-oriented information 70. Hereinafter, the area designated by the area condition information 84a is referred to as an “obtained area 5a”.

The value indicated by the area condition information 84a has the same meaning as the case of the delivery area information 81e shown in FIG. 8. Namely, if the area condition information 84a indicates “periphery=1” for example, a range of total nine areas that is extended from the area in which the user is located in eight directions by one area each becomes the obtained area 5a, as shown in FIGS. 9(a), 9(b) and 13(a).

The designation of the obtained area 5a, namely the area condition information 84a is performed as follows. The user gains access to a predetermined Web page of the brokerage system 1 so as to display an area condition setting screen HG2 shown in FIG. 14(a) on the receiving terminal device 3 of the user. The user selects an approximate extent of the area that the user thinks it is reasonable to receive the user-oriented information 70 from a group of selection buttons BG2. In addition, if there is a specific area that is interesting, an area ID of the area is entered in the text box TX21. Then, asetting button BN2 is clicked.

Then, the selected or entered contents are transmitted to the brokerage system 1 as the area condition information 84a. For example, if a selection button of “normal (1)” is selected, the area condition information 84a indicating “periphery=1” is transmitted.

Alternatively, a structure is possible in which the obtained area 5a can be designated on a setting screen in which a map is displayed as shown in FIG. 10 in the same manner as the case of designating the delivery area 5B.

The condition designation reception portion 102 shown in FIG. 4 accepts the area condition information 84a and stores the same in the user presence information table TL3 shown in FIG. 12(a) so as to interrelate with a user ID of the user who made the transmission.

The information transmission portion 107 performs a process for transmitting (delivering) the user-oriented information 70 to the receiving terminal device 3. A target of the delivery is a user who has the obtained area 5a that is overlapped with the delivery area 5B of the service provider ST who performed the delivery. Therefore, as shown in FIG. 9(a), a user who is located in an area E3 can be a target of delivery of the user-oriented information 70 by the service provider ST who is located in the area C5, but a user who is located in an area G7 cannot be a target of the delivery, for example.

A timing for performing the delivery is any one of three timings; (1) when the user-oriented information 70 is updated, i.e., when new user-oriented information 70 is uploaded to the brokerage system 1, (2) when the delivery area 5B is overlapped with the obtained area 5a by movement of the service provider ST who performed the delivery or the user or the like, (3) when there is a change in setting of the user or the service provider ST such as the area condition information 84a or the delivery area information 81e (see FIGS. 12(a) and 8). The delivery of the user-oriented information 70 is performed at each of the timings (1)-(3) in the following procedure.

In the case of the timing (1), the new information reception portion 101 informs the area calculation portion 105 that new user-oriented information 70 is uploaded. Then, the area calculation portion 105 determines the obtained area 5a of each user in accordance with the location information 83c and the area condition information 84a (see FIGS. 11 and 12(a)). Also, it determines the delivery area 5B of the service provider ST who delivered the user-oriented information 70 in accordance with the location information 81a and the delivery area information 81e (see FIG. 8).

The transmission permission determining portion 106 determines whether or not the determined obtained area 5a of each user is overlapped with the delivery area 5B of the service provider ST. Then, it is determined that the user-oriented information 70 can be delivered to a user who has the overlapping obtained area 5a, while it cannot be delivered to a user who does not have the overlapping obtained area 5a.

The information transmission portion 107 generates the user-oriented information 70 that is suitable for the receiving terminal device 3 of the user who is determined to be target of the delivery in accordance with the delivery-related information 81d and the binary data stored in the magnetic storage device 10d. More specifically, the user-oriented information 70 corresponding to a type of the terminal device indicated in the address information 83b is generated and delivered.

For example, if a type of the receiving terminal device 3 is a “mobile telephone terminal”, the user-oriented information 70 is summarized and delivered so that its contents are reduced corresponding to a size of the display screen. There are some methods for summarizing and delivering. For example, only some characters from the beginning (about ten characters, for example) are delivered, or an image is reduced or deleted before the delivery, or only a title or an important part is delivered. Alternatively, different user-oriented information 70 may be prepared for each type of the terminal device.

In the case of the timing (2), it is as follows. Whether the condition of the timing (2) is satisfied or not is monitored as follows. For example, the receiving terminal device 3 transmits the location information 81a indicating an area of a movement destination as the presence information 71 to the brokerage system 1 when the user moved from an area to another area as described above.

Then, the area calculation portion 105 determines the obtained area 5a in accordance with the new location information 81a of the user. Together with this, the delivery area 5B of each of the service providers ST is also determined. The transmission permission determining portion 106 determines whether or not the obtained area 5a of the user is overlapped with the delivery area 5B of each of the service providers ST. Then, it is determined that the user-oriented information 70 of the service provider ST having the overlapping delivery area 5B can be delivered to the user. It is determined that the user-oriented information 70 of the service provider ST who does not have the overlapping delivery area 5B cannot be delivered. Then, in the same manner as the case of the above-mentioned timing (1), the user-oriented information 70 that is determined to be able to be delivered is edited in accordance with a type of the receiving terminal device 3 and is delivered.

Note that if the service provider ST (a mobile shop, for example) moves from an area to another area, the transmission permission determining portion 106 determines whether or not a new delivery area 5B after the movement is overlapped with the obtained area 5a of each user. Then, the information transmission portion 107 delivers the user-oriented information 70 of the service provider ST to users having the overlapping obtained area 5a.

In the case of the timing (3), if the area condition information 84a of the user is updated for example, the area calculation portion 105 determines a new obtained area 5a in accordance with the area condition information 84a. The transmission permission determining portion 106 determines the service provider ST who has the delivery area 5B that is overlapped with the new obtained area 5a in the same manner as the case of the timing (2). Then, the information transmission portion 107 delivers the user-oriented information 70 of the service provider ST to the receiving terminal device 3 of the user.

Note that if the delivery area information 81e of the service provider ST is updated, the area calculation portion 105 determines the delivery area 5B of the service provider ST in accordance with the updated delivery area information 81e. The transmission permission determining portion 106 and the information transmission portion 107 determine the user who has the obtained area 5a that is overlapped with the new delivery area 5B and delivers the user-oriented information 70 of the service provider ST to the receiving terminal device 3 of the user.

In the receiving terminal device 3 that received the user-oriented information 70, a name of the service provider ST who delivered the user-oriented information 70 is displayed in a conspicuous manner as shown in the list display screen HG3 of FIG. 15(a). For example, the name is displayed in a thick font, or an icon EC3 is displayed for notifying that new user-oriented information 70 is received. In addition, the font may be an italic font, or the icon EC3 may be blinked.

When a cursor is adjusted on the icon EC3 or the name and the right mouse button is clicked, a menu list MN3 is displayed as shown in FIG. 15(b). Here, when “display detailed presence” is selected, contents of the user-oriented information 70 are displayed as an advertising information screen HG4 as shown in FIG. 16.

[The Case Where the Obtained Area 5a is Changed Responding to Movement Status of the User]

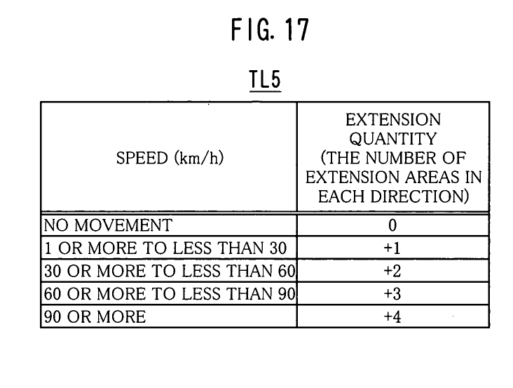

FIG. 17 is a diagram showing an example of an area extension table TL5. As described above, the user-oriented information 70 is delivered under the condition that the obtained area 5a of the user is overlapped with the delivery area 58 of the service provider ST. Therefore, there is a case where the user-oriented information 70 of the service provider ST is delivered to the user and the service provider ST is located a little away from the obtained area 5a viewed from the user. In this case, it is not proper to say there is no possibility that the user-oriented information 70 that is not desired by the user is delivered.

Therefore, in order to allow the user-oriented information 70 to be delivered more efficiently, it is possible to change the obtained area 5a corresponding to the movement status of the user and to determine whether or not the user-oriented information 70 should be delivered in accordance with the obtained area 5a. For example, it is possible to change the obtained area 5a in accordance with a speed and a direction of movement of the user and to deliver the user-oriented information 70 as follows.

The area extension table TL5 stores information that indicates extension quantity of the obtained area 5a responding to a speed of movement as shown in FIG. 17.

The area calculation portion 105 shown in FIG. 4 obtains the extension quantity of the obtained area 5a in accordance with this area extension table TL5 and a speed of the user indicated in the speed information 83d (see FIG. 11). For example, if the speed information 83d indicates “15 km/h”, the area extension table TL5 is referred to so that extension quantity “+1” is obtained.

Then, extension quantity “+1” is added to the area condition information 84a of the user (see FIG. 12(a)), and the obtained area 5a is determined in accordance with the area condition information 84a. Thus, the obtained area 5a having an extent shown in FIG. 13(a) is extended as shown in FIG. 13(b).

Further, among the extended obtained areas 5a, an area that is located on the opposite side to the movement direction of the user is erased. Namely, the area behind the user is erased. For example, if the direction information 83e of the user indicates the northwest direction (upper left direction), the areas in the southeast direction that are behind the present location of the user (the areas with hatching in FIG. 13(c)) are erased from the obtained area 5a as shown in FIG. 13(c).

The transmission permission determining portion 106 and the information transmission portion 107 determine whether or not the transmission (delivery) should be performed in accordance with the obtained area 5a that was determined in this way and perform the process for delivery.

In the same way, when the service provider ST moves, the delivery area 5B may be changed in accordance with a speed and direction of the movement.

[The Case Where it is Determined Whether or Not the Delivery Should be Performed in Accordance with a Distance Between Two]

The service providers ST can set the delivery area 5β of themselves freely. Therefore, it is possible to set the delivery area 5β very wide. In this case, however, there may be a problem that the user-oriented information 70 may be delivered even though the service provider ST is very far from the obtained area 5a for the user.

Therefore, it is possible to add a delivery condition that a distance between the service provider ST and the user is less than a distance designated by the user. Hereinafter, such a condition may be referred to as a “distance condition”. Namely, even if the obtained area 5a is overlapped with the delivery area 5β, the user-oriented information 70 is not delivered if a distance between them is larger than the distance designated by the user (if the distance condition is not satisfied). The determination whether or not the delivery should be performed in accordance with the distance condition is performed as follows. Note that a distance between the service provider ST and the user is indicated by a distance between the area where the service provider ST is located and the obtained area 5a of the user in this embodiment.

The obtaining condition table TL4 stores the distance condition information 84b of each user as shown in FIG. 12(a). The distance condition information 84b expresses the distance condition by the number of areas that exist between the area where the service provider ST is located and the obtained area 5a of the user.

For example, it is supposed that the distance condition information 84b of a user is “1”. If a distance between the obtained area 5a of the user and the service provider ST is within one area as shown in FIG. 9(a), the transmission permission determining portion 106 shown in FIG. 4 determines that the user-oriented information 70 can be delivered to the user. In contrast, if the distance between them is one area or more as shown in FIG. 9(b), it is determined that the user-oriented information 70 cannot be delivered.

[The Case Where it is Determined Whether or Not the Delivery Should be Performed in Accordance with a Category]

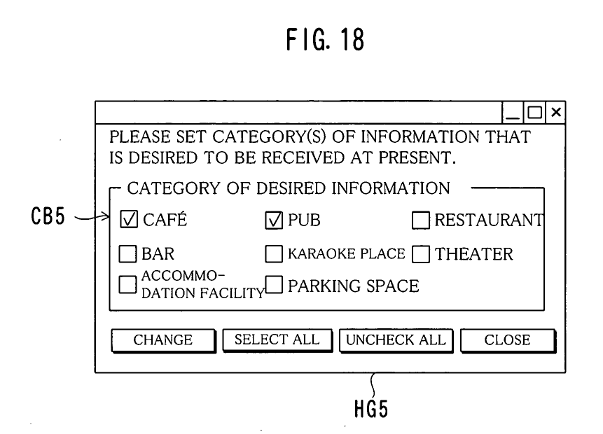

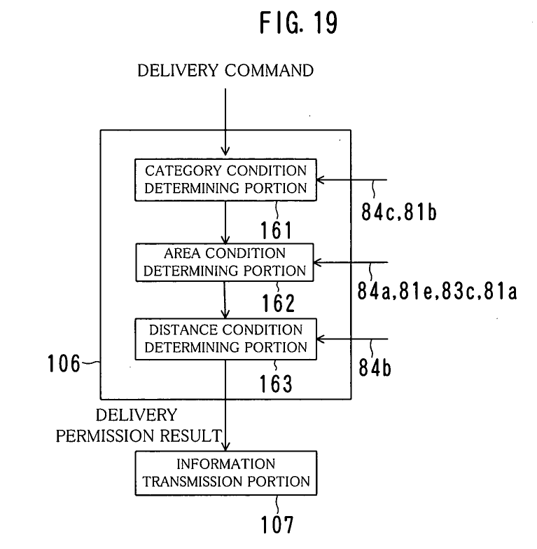

FIG. 18 is a diagram showing an example of a category selecting screen HG5, and FIG. 19 is a diagram showing an example of a structure of a transmission permission determining portion 106.

In order that the user-oriented information 70 is delivered more efficiently, it is possible to add a delivery condition that a category of contents of the user-oriented information 70 is included in a favorite category of the user. Hereinafter, this condition may be referred to as a “category condition”. In this case, the brokerage system 1 or the like is configured as follows.

As shown in FIG. 8, each of the service providers ST registers the category information 81b in the service provider table TL1, and the category information 81b indicates a category of contents of the user-oriented information 70 delivered by the service provider ST. The registration is performed by using a pull-down menu DM6 on the information setting screen HG6 shown in FIG. 2. Namely, the pull-down menu DM6 is clicked so that a list of categories is displayed. Then, one of categories is selected from the list.

Each of the users registers one or more desired categories (category condition 84c) in the obtaining condition table TL4′ as shown in FIG. 12(b). For example, the user of “user ID=A001” registers two categories “cafe” and “pub”. The registration is performed by selecting one or more desired categories from a group of check boxes CB5 on the category selecting screen HG5 shown in FIG. 18.

In addition, the user can set the obtained area 5a (area condition information 84a) and the distance condition (distance condition information 84b) for each of the desired categories. This setting is performed on the area condition setting screen HG2′ shown in FIG. 14(b) in the following procedure.

When a pull-down menu DM2 is clicked, a list of the categories desired by the user is displayed. Among the list, a category for setting the area condition information 84a and the distance condition information 84b is selected. In FIG. 14(b), “cafe” is selected.

An extent of the obtained area 5a that is set for the category is selected from a group of selection buttons BG2′. Alternatively, an area ID is entered in a text box TX21′. Thus, the area condition information 84a of the category is set.

Furthermore, the distance condition is selected by using a selection button SB21 or SB22, or a text box TX22. Namely, the selection button SB22 is checked, and a distance to be set (the number of areas indicating a distance between the obtained area 5a and the service provider ST) is entered in the text box TX22. Thus, the distance condition information 84b is set. Note that if the distance condition is not designated, the selection button SB21 is selected.

The transmission permission determining portion 106 shown in FIG. 4 is configured to include a category condition determining portion 161, an area condition determining portion 162 and a distance condition determining portion 163 as shown in FIG. 19. Such a structure enables to determine whether or not the delivery should be performed as follows.

For example, it is supposed that new user-oriented information 70 is uploaded to the brokerage system 1. Then, the category condition determining portion 161 obtains category information 81b of the user-oriented information 70 from the service provider table TL1 shown in FIG. 8. The obtaining condition table TL4′ shown in FIG. 12(b) is referred to so that a user having the same category as the category indicated in the obtained category information 81b is searched. For example, if the category information 81b indicates “cafe”, a user whose user ID is “A001” is obtained.

The area condition determining portion 162 determines whether or not the obtained area 5a of the user obtained by the search is overlapped with the delivery area 5β of the service provider ST who delivered the user-oriented information 70. The determining method is as described above.

In addition, the distance condition determining portion 163 determines whether or not the distance condition is satisfied, i.e., whether the number of areas that exist between the obtained area 5a of the user and the service provider ST is less than a value indicated in the area condition information 84a.

Then, if it is determined that the distance condition is satisfied, the information transmission portion 107 transmits (delivers) the user-oriented information 70 to the user. If it is determined that the distance condition is not satisfied, the user-oriented information 70 is not transmitted to the user regardless of the determination results of the category condition determining portion 161 and the area condition determining portion 162.

[Provision of Member-Oriented Information]

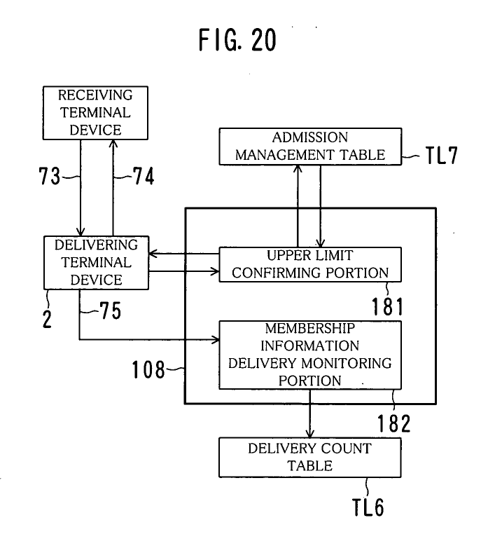

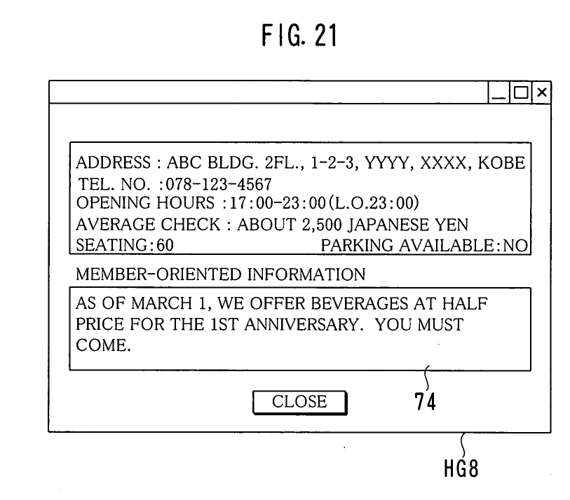

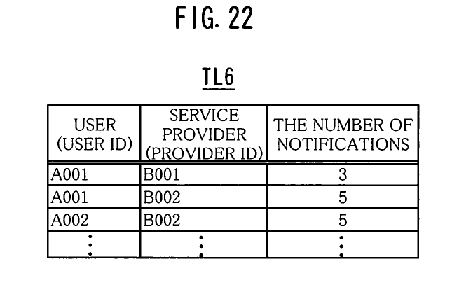

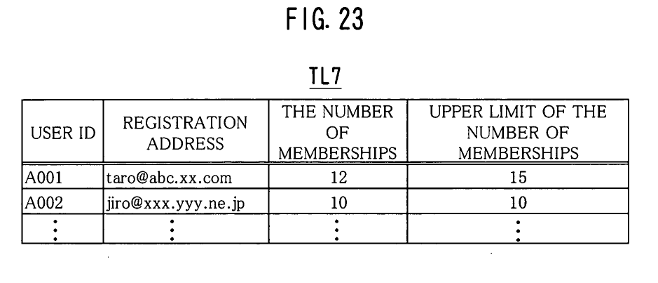

FIG. 20 is a diagram showing an example of a structure of a membership registration management portion 108, FIG. 21 is a diagram showing an example of a membership information screen HG8, FIG. 22 is a diagram showing an example of a delivery count table TL6, and FIG. 23 is a diagram showing an example of an admission management table TL7.

The user reads or views the user-oriented information 70 (see FIG. 16) of the service provider ST delivered from the brokerage system 1. If the user becomes fond of the service provider ST, the user can become a member of a society of the service provider ST. The user who is the member can receive provision of information that is limited to members (member-oriented information 74) from the service provider ST. A process for registering a membership and providing the member-oriented information 74 is performed as follows.

The membership registration management portion 108 shown in FIG. 4 is configured to include an upper limit confirming portion 181 and a membership information delivery monitoring portion 182 as shown in FIG. 20.

When the advertising information screen HG4 (see FIG. 16) and the list display screen HG3 (FIG. 15(b)) are generated, “membership registration” in a membership registration button BN4 and the menu list MN3 becomes interrelated with link information to an address (URL) indicated by the membership registration address 81c shown in FIG. 8. Therefore, the membership registration button BN4 or the “membership registration” is clicked in the receiving terminal device 3, it is possible to gain access to a Web page for membership registration in accordance with the link information.

The address for membership registration may be an IM address of the service provider ST. In this case, when the membership registration button BN4 or the “membership registration” is clicked in the receiving terminal device 3, information is subscribed or the subscription is noticed by gaining access to the IM address or by other method, and then the membership registration is completed.

The user enters intention of being a member, a user ID and an electronic mail address in the Web page. Then, the entered information is transmitted as registration request information 73 to the delivering terminal device 2 of the service provider ST who operates the society. The delivering terminal device 2 accepts the information and registers the user ID and the electronic mail address of the user in a management database 2DB (see FIG. 1). Thus, the membership registration process is completed.

The service provider ST delivers the member-oriented information 74 only to members. The member-oriented information 74 is directly delivered to the receiving terminal device 3 of the user who is a member with bypassing the brokerage system 1. In addition, the member-oriented information 74 is delivered every time when its contents are updated. Therefore, the user can read the latest member-oriented information 74 promptly. The membership information screen HG8 as shown in FIG. 21 is displayed on the delivering terminal device 2 of a member who received the member-oriented information 74.

Note that it is possible to obtain information about interests or tastes of the user on the membership registration and to deliver the member-oriented information 74 that is customized for each user in accordance with the information obtained from the user. Alternatively, it is possible to store history information of goods or the like that the user has purchased from the service provider ST in the past, and to perform the customizing in accordance with the history information.

The member-oriented information 74 is delivered regardless of a location relationship between the user and the service provider ST as a general rule. However, it is possible to deliver other member-oriented information 74′ only to members who visited near the service provider ST.

In this case, the brokerage system 1 is asked about whether or not the delivery should be performed. The transmission permission determining portion 106 (see FIG. 4) of the brokerage system 1 determines whether the obtained area 5a of each member is overlapped with the delivery area 5β of the service provider ST. Then, members having the obtained area 5a that is overlapped with the delivery area 5β are reported to the delivering terminal device 2. The delivering terminal device 2 delivers the member-oriented information 74′ only to the members indicated in the report.

The membership information delivery monitoring portion 182 shown in FIG. 20 monitors the number of member-oriented information 74 that was delivered to members by the service provider ST. Namely, every time when the delivering terminal device 2 delivers the member-oriented information 74, delivery status information 75 is obtained that indicates which user (member) was a destination of the delivery. Then, the number of deliveries of the member-oriented information 74 is recorded in the delivery count table TL6 for each combination of each user who is a delivery destination and the service provider ST who performed the delivery as shown in FIG. 22. Not only the number of notice times but also a category including quantity of information, a type of data and contents of information may be recorded. The delivering terminal device 2 may transmit the delivery status information 75 to the brokerage system 1 at a predetermined timing (every one week, for example) by bundling the information.

An administrator of the brokerage system 1 refers to the delivery count table TL6 and makes a request of a commission to the service provider ST in accordance with the delivery status including the number of delivered member-oriented information 74, quantity of data, a type of data and a category of contents of the information. In addition, it is possible to collect an introduction fee on every membership registration.

If one user makes registration of membership in many service providers ST, the user will want to receive the member-oriented information 74 prior to the user-oriented information 70. Therefore, the user may narrow his or her range of the obtained area 501, so as not to receive many user-oriented information 70. Therefore, frequency of using the brokerage system 1 may be decreased.

Therefore, in order to maintain the frequency of using the brokerage system 1, it is possible to set a limitation of number of membership registration that one user can make (upper limit of the number of memberships) by using the admission management table TL7 as shown in FIG. 23, for example.

When the delivering terminal device 2 receives the registration request information 73 from the user, it inquires of the brokerage system 1 whether or not the user can be registered. Then, the upper limit confirming portion 181 refers to the admission management table TL7 and confirms whether the number of memberships of the user at present has reached the upper limit of the number of memberships. If the number of memberships of the user has already reached the upper limit of the number of memberships, it is answered that the user cannot be registered. If the present number of memberships of the user has not reached the upper limit of the number of memberships, it is answered that the user can be registered, and the present number of memberships of the user in the admission management table TL7 is incremented by one.

The user whose present number of memberships has already reached the upper limit of the number of memberships cannot register a new membership unless the user withdraws from one of societies in which the user is registered at present. It is configured that the user can select any one of societies to withdraw. Alternatively, a structure is possible in which the user automatically withdraws from one of societies that is the oldest or has the least frequency of usage. It is possible that the “upper limit of the number of memberships” can be increased when the user pays a fee to the brokerage system 1.

Alternatively, a structure is possible in which when a predetermined period (a few months, for example) has passed after the membership registration, the user automatically withdraws from the society. In this case, it is considered that there is a case where the user tries to remake the membership registration on the screen of the user-oriented information 70 (the advertising information screen HG4 shown in FIG. 16 or the like) that the user has received before. If this is possible, it is not necessary to receive new user-oriented information 70, resulting in that frequency of using the brokerage system 1 is not increased. Therefore, it is possible to change a URL of the Web page for membership registration (the membership registration address 81c shown in FIG. 8) regularly.

In this way, as the address (URL) of the Web page for membership registration is temporary one, the link information included in the user-oriented information 70 that is received before becomes invalid (link expiration). Therefore, the user who has withdrawn from a society has to receive new user-oriented information 70 for gaining access to the Web page for membership registration and making membership registration. Therefore, usage of the brokerage system 1 can be promoted. Note that it is possible to configure that the user can pay a fee to the brokerage system 1 for extending a period until withdrawing (valid period of the membership).

It is possible to prepare the member-oriented information 74 for each shop and the member-oriented information 74 that is common to all shops so as to support the case where one service provider ST owns plural shops. Then, as to the member-oriented information 74 for each shop, the brokerage system 1 is inquired a present location of the user, a shop that is located at a position closest to the user is determined, and only the member-oriented information 74 of the shop is delivered. Alternatively, it is possible to provide configuration in which the user can select a shop that the user wants the member-oriented information 74 on the membership registration. Thus, the service provider ST who develops the business throughout the country can deliver the member-oriented information 74 with high efficiency.

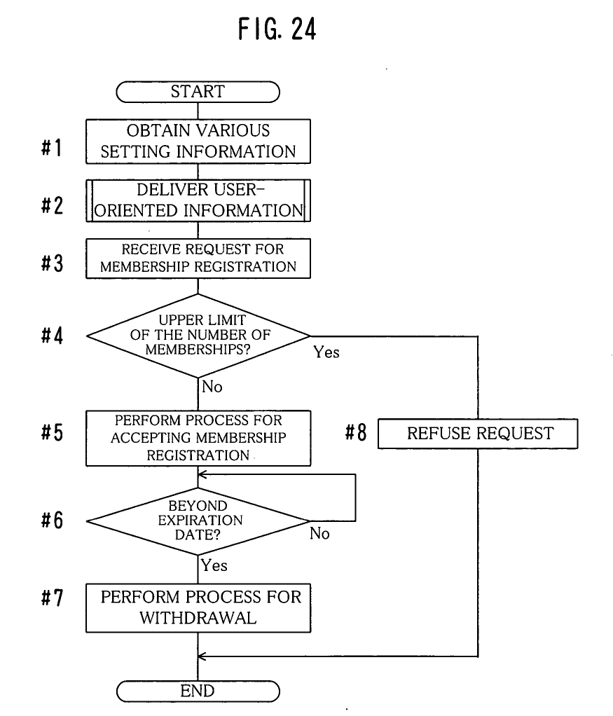

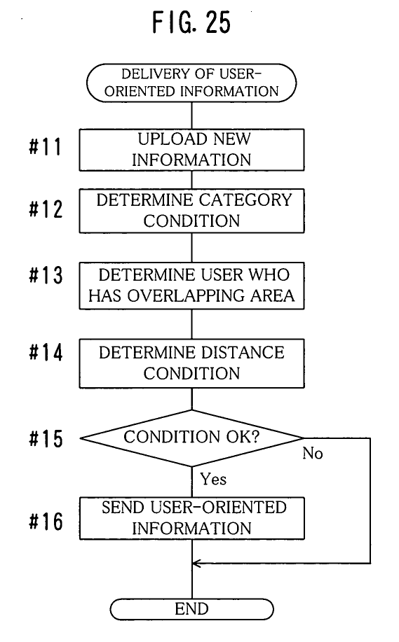

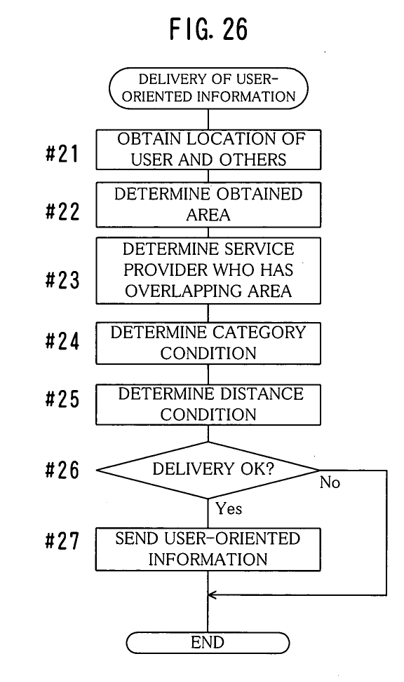

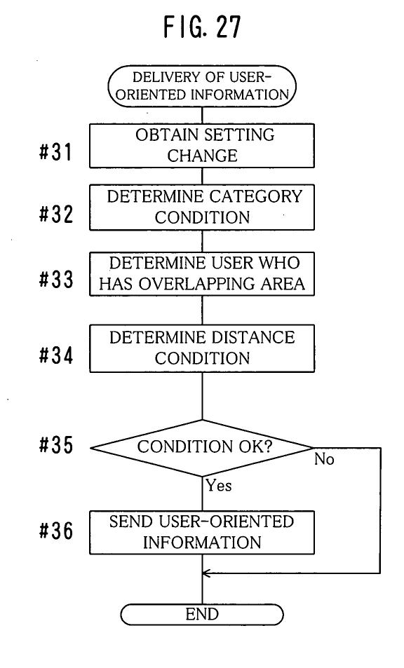

FIG. 24 is a flowchart showing an example of a flow of a general process of the information transmission and reception system 100, FIG. 25 is a flowchart showing an example of a flow of a process for delivering user-oriented information in a case of timing (1), FIG. 26 is a flowchart showing an example of a flow of a process for delivering user-oriented information in a case of timing (2), and FIG. 27 is a flowchart showing an example of a flow of a process for delivering user-oriented information in a case of timing (3).

Next, a flow of a process of the information transmission and reception system 100 will be described with reference to flowcharts.

As shown in FIG. 24, the brokerage system 1 obtains information that is necessary for determining the obtained area 5a, the delivery area 5β and the like from each of the users and each of the service providers ST (#1).

The delivery of the user-oriented information 70 is performed at the timing (1)-(3) described above (#2). In the case of the timing (1), i.e., if new user-oriented information 70 is uploaded, the delivery is performed in the procedure shown in FIG. 25. When new user-oriented information 70 is uploaded to the brokerage system 1 (#11), users having the same category as a category of the user-oriented information 70 are determined (#12). Among users having the same category, users who has the obtained area 5a that is overlapped with the delivery area 5β of the service provider ST who performed the delivery of the user-oriented information 70 are determined (#13). Further, among the users having the obtained area 5a that is overlapped with the delivery area 5B, users who satisfy the distance condition are determined (#14). Note that the order of the determinations in Steps #12-#14 can be changed if necessary.

Then, the user-oriented information 70 is transmitted to users who have the same category and the obtained area 5a that is overlapped with the delivery area 5B and satisfy the distance condition (Yes in #15). If any condition is lacked (No in #15), transmission to the user is not performed.

In the case of the timing (2), i.e., if the delivery area 5B is overlapped with the obtained area 5a due to movement of the user or the like, the delivery is performed in the procedure as shown in FIG. 26. Location information indicating an area that is a destination of movement of the user is obtained (#21). A new obtained area 5a is determined in accordance with the location information (#22).

The service providers having the delivery area 5B that is overlapped with the new obtained area 5a is determined (#22), and further, among the determined service providers ST, the service provider ST satisfying the category condition and the distance condition is determined (#23 and #24). The order of the determinations in Step #23-#25 can be changed if necessary.

Then, the user-oriented information 70 of the service provider ST who has the delivery area 5B that is overlapped with the new obtained area 5a and the same category as the moved user and satisfies the distance condition is delivered to the user (Yes in #26, and #27). The user-oriented information 70 of the service provider ST who has any condition that is not satisfied is not delivered here (No in #26).

In the case of the timing (3), i.e., if there is a change in setting, the delivery is performed in the procedure as shown in FIG. 27. For example, it is supposed that a user's desired category is changed. The brokerage system 1 obtains information of a new category that was changed (#31).

The service provider ST is determined who has the user-oriented information 70 of the same category as the new category of the user and the delivery area 5B that is overlapped with the obtained area 5a of the user and satisfies the distance condition designated by the user (#32-#34). Then, the user-oriented information 70 of the service provider ST who satisfies these conditions is delivered to the user (Yes in #35, and #36).

With reference to FIG. 24 again, when the delivering terminal device 2 receives a request for entrance to a society operated by the service provider ST (#3), it refers to the admission management table TL7 shown in FIG. 23 and determines whether or not the present number of memberships of the user who made the request has reached the upper limit of the number of memberships (#4). If the present number of memberships has already reached the upper limit of the number of memberships (Yes in #4), the request for entrance to a society is refused (#8). Otherwise (No in #4), the request is accepted, and the service provider ST is informed of a user ID, an electronic mail address and the like of the user who made the request (#5).

If the valid period is expired after entering the society (Yes in #6), the notice of it is sent to the user who is a member, and a process for withdrawal is performed (#7).

According to this embodiment, whether or not the user-oriented information 70 should be delivered is determined in accordance not only with the designated delivery area 5B of the service provider ST but also with the obtained area 5a designated for each user. Therefore, information of the service provider can be delivered to the user more efficiently than before.

Furthermore, since the category condition or the distance condition is combined for the determination, information of the service provider can be delivered to users more efficiently.

In addition, the delivered user-oriented information 70 can be used as a trigger of advising the user to be a member of the society operated by the service provider ST.

In this embodiment, if a predetermined condition is satisfied, the user-oriented information 70 is delivered to the receiving terminal device 3 of the user promptly. However, if storage capacity of the receiving terminal device 3 is small, there may be the case where all the user-oriented information 70 cannot be stored at one time. Therefore, if a predetermined condition is satisfied, only a notice that there is user-oriented information 70 that is capable of being delivered may be sent to the receiving terminal device 3. In this case, the receiving terminal device 3 displays a name of the service provider ST having the user-oriented information 70 that can be delivered in a conspicuous manner as shown in the list display screen HG3 of FIG. 15(a). Alternatively, it is possible to output a message of advising reception in characters or in sound. Then, the brokerage system 1 delivers the user-oriented information 70 at a timing when the name was selected.

It is possible to collect a fee for delivery of the user-oriented information 70 by the brokerage system 1 from the service provider ST. In this case, the accounting is performed in accordance with the number of deliveries of the user-oriented information 70, quantity of information, a type of the data, a category of contents of the information, a storing period in the brokerage system 1 or the like. Alternatively, it is possible to perform the accounting in accordance with an extent of the set delivery area 5B. It is also possible to change the accounting price for each delivery area 5B.

It is possible to use an existing system for performing a process of delivering the user-oriented information 70 or the member-oriented information 74. For example, if “FLAIRINC (flare link)” of Fijitsu Limited is used, information can be delivered in accordance with a present location of a user or a desired category.

Although the distance condition is designated by the number of areas that exist between the obtained area 5a of the user and the service provider ST in this embodiment, it is possible to designate the distance condition by a usual unit such as meters or yards. It is possible to designate the same by a distance between the user and the service provider ST.

The brokerage system 1 delivers the user-oriented information 70 if there is a change in the information, the status or the setting (if there is a so-called change of presence), for example if new user-oriented information 70 is uploaded or the present location of the user is changed. Namely, a PUSH type delivery is performed. However, it is possible of course that the brokerage system 1 delivers the user-oriented information 70 responding to a request from a user (a PULL type delivery).

It is possible to determine whether or not the delivery should be performed in accordance with a condition except the category condition and the distance condition. For example, the service provider ST sets a day of the week or a time zone (business hours, for example) for delivering the user-oriented information 70. Then, when the obtained area 5a of the user is overlapped with the delivery area 5B of the service provider ST, the user-oriented information 70 is delivered if the present date corresponds to the day of the week and the time zone. Alternatively, the user sets a day of the week or a time zone for receiving the user-oriented information 70, and whether or not the delivery should be performed may be determined in accordance with the set day of the week or time zone.

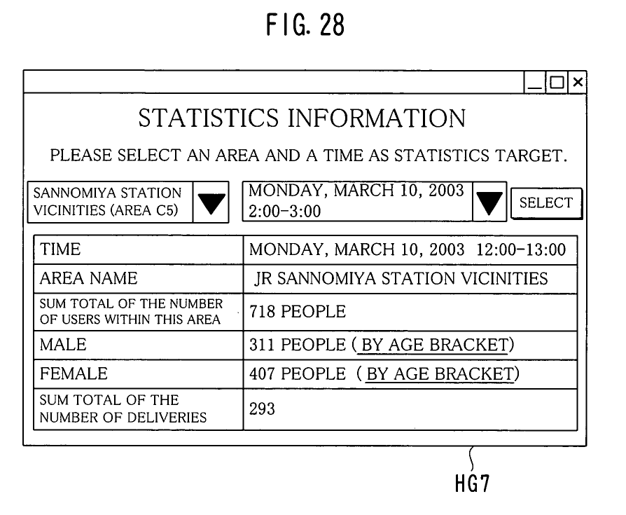

FIG. 28 is a diagram showing an example of a statistics screen HG7. It is possible to record a history of delivering the user-oriented information 70 and to provide the record of the history to the service provider ST. Alternatively, it is possible to obtain statistics on the present location of each user in accordance with the user presence information table TL3 shown in FIG. 11 and to provide the same to the service provider ST. For example, it is possible to obtain statistics on the number of users who exist in the designated area responding to the request from the service provider ST and to provide the information thereof. In addition, it is possible to register age and gender of each user in the obtaining condition table TL4 as shown in FIG. 12(a) or the like in advance and to obtain statistics for each age or gender. It is possible to keep a history of location of each user so that statistics on the past can be obtained. A statistics screen HG7 as shown in FIG. 28 is displayed on the delivering terminal device 2 of the service provider ST who was provided with the information.

Alternatively, it is possible to notify information of the statistics regularly (every week, for example). It is possible to provide a structure in which when the service provider ST satisfies the designated condition, it is notified. For example, if the condition “area=C5, the number of users=100” is designated, it is notified when 100 or more users gather in the area C5. The brokerage system 1 may receive compensation corresponding to the number of notifications of information or quantity of information from the service provider ST.

It is possible that the delivering terminal device 2 or the receiving terminal device 3 is provided with a function of checking the upper limit of the number of memberships of the upper limit confirming portion 181 as well as a function for withdrawal after a predetermined period has passed and that each of the terminal devices manages the membership registration.

It is possible that the brokerage system 1 is provided with means for calculating a commission for delivery of the user-oriented information 70 and the member-oriented information 74, and for introduction of a member or the like, and generating information about a commission (accounting information) to be collected from each of the service providers ST.

Furthermore, the structure of the entire or a part of the information transmission and reception system 100, the brokerage system 1, the delivering terminal device 2, and the receiving terminal device 3, the contents of the tables, the structures of the screens, the contents of the processes, the order of the processes, and the conditions for determining whether or not the delivery should be performed can be changed in accordance with the spirit of the present invention, if necessary.

### INDUSTRIAL APPLICABILITY

As described above, the present invention is useful in that information of an information provider can be delivered to a user more efficiently than before.

1. An information provision brokerage system comprising:
a provider information storage portion for storing provider area information and provision information for each information provider, the provider area information indicating an area designated by the information provider, and the provision information being to be provided by the information provider;
a user information storage portion for storing user area information for each user who has a terminal device, the user area information indicating an area designated by the user;
a determining portion for determining whether or not an area indicated by the provider area information overlaps an area indicated by the user area information; and
an information transmission portion for transmitting the provision information of the information provider according to the provider area information to a terminal device of the user according to the user area information if it is determined that the area indicated by the provider area information overlaps the area indicated by the user area information.

2. The information provision brokerage system according to claim 1, wherein:
an area in which the provision information can be provided is divided into plural segment areas,
the provider information storage portion stores the provider area information that indicates the segment area,
the user information storage portion stores the user area information that indicates the segment area, and
the determining portion performs the determination by determining whether or not the same segment area is included both in the segment area indicated by the provider area information and in the segment area indicated by the user area information.

3. The information provision brokerage system according to claim 1, comprising a movement information obtaining portion for obtaining movement information that indicates a speed and a direction of movement of the user, and an area information changing portion for changing the user area information of the user in accordance with the movement information of the user, wherein the determining portion performs the determination in accordance with the user area information changed by the area information changing portion.

4. The information provision brokerage system according to claim 1, wherein the provision information storage portion stores category information that indicates a category of contents of the provision information in association with the provision information, the user information storage portion stores category information that indicates a category of information desired by the user in association with the user, and the information transmission portion transmits the provision information if a category of contents of the provision information to be transmitted is included in a category of information desired by the user who is a destination of the transmission.

5. The information provision brokerage system according to claim 1, wherein the provision information storage portion stores provider location information that indicates a location of the information provider in association with the information provider, the user information storage portion stores user location information that indicates a location of the user and a distance designated by the user in association with the user, and the information transmission portion transmits the provision information if a distance between a location of the information provider who provides the provision information to be transmitted and a location of the user who is a destination of the transmission is smaller than the distance designated by the user.

6. The information provision brokerage system according to claim 1, wherein the provision information includes information for advising an application for receiving information delivery from the information provider who transmits the provision information.

7. The information provision brokerage system according to claim 6, comprising a delivery status management portion for managing a delivery status of information that is delivered directly from the information provider to the user who made the application, and an accounting information generation portion for counting delivery statuses of the information providers at a predetermined timing so as to generate accounting information to the information provider.

8. An information provision brokerage system comprising:
a provider information storage portion for storing provider area information and provision information for each information provider, the provider area information indicating an area designated by the information provider, and the provision information being to be provided by the information provider;
a user information storage portion for storing user area information for each user who has a terminal device, the user area information indicating an area designated by the user;
a determining portion for determining whether or not an area indicated by the provider area information overlaps an area indicated by the user area information;
a notification portion for sending a notification to a terminal device of the user according to the user area information so that the user receives the provision information of the information provider according to the provider area information if it is determined that the area indicated by the provider area information overlaps the area indicated by the user area information; and
an information transmission portion for transmitting the provision information of the information provider to the terminal device of the user responding to a request from the user who received the notification.

9. A server that is connected to an information providing server for providing information of plural information providers in accordance with location information of users via a network, the server comprising:
a user registration portion for receiving an application from the user for information delivery so as to register the user as an information delivery destination user;
an information delivery portion for performing delivery of information to the user who is registered as the information delivery destination user;
a delivery status management portion for managing a delivery status of information; and
a delivery status notification portion for notifying the information providing server of the delivery status.

10. An information provision brokerage method, comprising the steps of:
making a provider information storage portion store provider area information and provision information for each information provider in advance, the provider area information indicating an area designated by the information provider, and the provision information being to be provided by the information provider;
making a user information storage portion store user area information in advance for each user who has a terminal device, the user area information indicating an area designated by the user;
determining whether or not an area indicated by the provider area information overlaps an area indicated by the user area information; and
transmitting the provision information of the information provider according to the provider area information to a terminal device of the user according to the user area information if it is determined that the area indicated by the provider area information overlaps the area indicated by the user area information.

11. A computer program for use in a computer that performs brokerage for information transmission from an information provider to a user, the computer program makes the computer perform the process comprising the steps of:
reading provider area information corresponding to provision information to be transmitted from a provider information storage portion that stores the provider area information and the provision information in an interrelated manner for each information provider, the provider area information indicating an area designated by the information provider and the provision information being to be provided by the information provider;
reading user area information of a user who is a destination of the transmission from a user information storage portion that stores the user area information for each user, the user area information indicating an area designated by the user;
determining whether or not an area indicated by the read provider area information overlaps an area indicated by the read user area information; and
transmitting the provision information corresponding to the provider area information to a terminal device of the user according to the user area information if it is determined that the area indicated by the provider area information overlaps the area indicated by the user area information.
